(19) United States
(12) Patent Application Publication
(10) Pub. No.: US 2026/0023533 A1
(43) Pub. Date: Jan. 22, 2026

(54) RING-GENERATOR-BASED TRUE RANDOM NUMBER GENERATOR FOR HARDWARE ROOT OF TRUST

(71) Applicant: Siemens Industry Software Inc., Plano, TX (US)

(72) Inventors: Janusz Rajski, West Linn, OR (US); Maciej Trawka, Pruszcz Gdanski (PL); Jerzy Tyszer, Poznan (PL)

(73) Assignee: Siemens Industry Software Inc., Plano, TX (US)

(21) Appl. No.: 19/099,880

(22) PCT Filed: Aug. 8, 2022
(86) PCT No.: PCT/US2022/074652

§ 371 Date: Jan. 30, 2025

(51) Int. Cl. G06F 7/58

(52) U.S. Cl. CPC G06F 7/588

(57) ABSTRACT

A random number generator comprises a ring generator and one or more inverter-based ring oscillators. The one or more inverter-based ring oscillators is configured to inject bits into the ring generator at a plurality of location. If there is more than one inverter-based ring oscillators, the inverter-based ring oscillators may have different numbers of inverting elements and may inject bits into the ring generator at different locations. At least one of the one or more inverterbased ring oscillators may be configured to inject bits into the ring generator at different locations from outputs of some or all its inverting elements. The random number generator may further comprise blocking circuitry configured to convert, based on a blocking signal, the ring generator into a circular shift register by blocking both the injection from the plurality of inverter-based ring oscillators and internal feedbacks in the ring generator.

### FIELD OF THE DISCLOSED TECHNIQUES

The presently disclosed techniques relate to the field of hardware security and trust. Various implementations of the disclosed techniques may be particularly useful for designing and using true random number generators and associated hardware roots of trust to protect circuits against malicious activities and hacking attempts.

### BACKGROUND OF THE DISCLOSED TECHNIQUES

The huge cost of building and maintaining integrated circuit manufacturing has pushed many semiconductor companies to become fabless, outsourcing the expensive fabrication process to foundries. The lack of reliable monitoring and trustworthiness to offshore fabrication and testing processes increases security threats. Hardware security threats can be in many forms including intellectual property (IP) piracy, overproduction, counterfeiting, reverse engineering, and insertion of hardware Trojans.

To mitigate the security risks, various defense solutions have been proposed such as logic locking, circuit obfuscation, password-based authentication, challenge-response protocols, and data encryption. The foundation on which many secure operations of an integrated circuit depend is typically defined as a hardware root of trust (RoT). Hardware roots of trust can perform specific, critical security functions. For example, high-end roots of trust are usually integrated into silicon as separate, custom-designed security modules—immune from malware attacks—that handle chip and device identities, cryptographic keys and functions, secure boot processes, attestation, authentication, firmware updates, etc. As a security vehicle, the hardware root of trust should be capable of detecting the intrusion, disabling access pending further actions, and/or obfuscating (camouflaging) logic operations of the IC. Choosing an adequate root of trust depends on many factors, such as a threat model, potential risks, a desired level of protection, programmability, silicon overhead, impact on performance, or the complexity of crypto algorithms and ciphers.

Existing hardware roots of trust are facing many challenges. One challenge is about tradeoffs between meeting security demands and preserving functionality and testability. Another challenge is the complexity of several existing solutions and their impact on area overhead and the design flow. These challenges can make integrated circuit vendors hesitate to adopt the existing solution. An effective and non-intrusive lightweight hardware root of trust is thus highly desirable.

Random number generators are commonly used in a hardware root of trust module. While pseudorandom number generators can generate a large number of non-repeated pattern sequences, these non-repeated pattern sequences are deterministic in nature and thus vulnerable to cryptanalytic attacks. Different from pseudorandom number generators based on complex but deterministic patterns, true random number generators can generate random numbers based on various stochastic characteristics, such as the thermal noise, metastability, quantum effects, phase jitter or glitch of digital circuits. A true random number generator circuit is expected to not only leverage these hard-to-measure physical characteristics to generate random numbers, but also be easily designed, synthesized, and implemented with modern digital design blocks.

### BRIEF SUMMARY OF THE DISCLOSED TECHNIQUES

Various aspects of the disclosed technology relate to ring-generator-based true random number generators and hardware root of trust circuits constructed based on them. In one aspect, there is a circuit, comprising: a random number generator, the random number generator comprising: a ring generator; and one or more inverter-based ring oscillators, the one or more inverter-based ring oscillators configured to inject bits into the ring generator at a plurality of location.

If the one or more inverter-based ring oscillators have more than one inverter-based ring oscillators, the one or more inverter-based ring oscillators may have different numbers of inverting elements (inverting devices) and may inject bits into the ring generator at different locations.

At least one of the one or more inverter-based ring oscillators may be configured to inject bits into the ring generator at different locations from outputs of some or all inverting elements in the at least one of the one or more inverter-based ring oscillators.

The random number generator may further comprise: blocking circuitry configured to convert, based on a blocking signal, the ring generator into a circular shift register by blocking both the injection from the one or more inverter-based ring oscillators and internal feedbacks in the ring generator. The circuit may further comprise a counter configured to generate the blocking signal, the blocking being enabled after a predefined number of clock cycles indicated by the counter. The blocking circuitry may comprise a plurality of AND gates.

The circuit may further comprise hashing circuitry configured to mimic a hashing function that can transform a random number outputted from the random number generator into a hash value. The hashing circuitry may comprise: combinational circuitry comprising nonlinear Boolean operators formed by logic gates, the combinational circuitry configured to receive the random number; and a ring generator configured to be initialized by a secret key, to be injected with bits from outputs of the combinational circuitry, and to output the hash value after a predefined number of clock cycles.

The circuit may still further comprise retrieving circuitry configured to use the hash value to retrieve one or more configuration masks from a response signal received by the circuit, wherein the response signal is generated based on the random number by a computing device, the generating of the response signal comprising: generating the hash value for the random number, and combining the hash value with the one or more configuration masks.

The circuit may still further comprise a descrambler configured to use a configuration mask in the one or more configuration masks to descramble a signal received by the circuit, a scrambler configured to use a configuration mask in the one or more configuration masks to scramble a signal to be sent out by the circuit, or both.

The descrambling the signal may comprise retrieving compressed test patterns from encrypted compressed test patterns received by the circuit.

The circuit may still further comprise a multiple-input signature register configured to compact test responses during a self-test, wherein the random number generator is further configured to operate as a pseudorandom test pattern generator by blocking the injection from the one or more inverter-based ring oscillators.

The circuit may still further comprise a controller configured to supervise a authentication process, the authentication process comprising: generating the random number by the random number generator, converting the random number into the hash value by the hashing circuitry, and retrieving, by the retrieving circuitry, the one or more configuration masks from the response signal received by the circuit based on the hash value. The controller may comprise a finite state machine. The controller may be further configured to control a test process for self-testing of the random number generator, the hashing circuitry, and the retrieving circuitry.

In another aspect, there are one or more non-transitory computer-readable media storing computer-executable instructions for causing one or more processors to perform a method, the method comprising: creating the above circuit in a circuit design.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed techniques. Thus, for example, those skilled in the art will recognize that the disclosed techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1A illustrates an example of a true random number generator that may be implemented according to various embodiments of the disclosed technology.

FIG. 1B illustrates another example of a true random number generator that may be implemented according to various embodiments of the disclosed technology.

FIG. 2A illustrates an example of a 28-bit ring generator implementing a primitive characteristic polynomial.

FIG. 2B illustrates an example of a 28-bit dense ring generator implementing a primitive characteristic polynomial.

FIG. 3A illustrates an example 28-bit true random number generator based on a 28-bit dense ring generator that may be implemented according to various embodiments of the disclosed technology.

FIG. 3B illustrates an example 32-bit true random number generator based on a 32-bit ring generator that may be implemented according to various embodiments of the disclosed technology.

FIG. 4 illustrates an example 28-bit true random number generator having built-in block circuitry that may be implemented according to various embodiments of the disclosed technology.

FIG. 5 illustrates an example distribution of 0s and 1s obtained for a 64-bit true random number generator.

FIG. 6 illustrates a histogram of 1s observed on successive bits of 64-bit-true-random-number-generator-produced numbers.

FIG. 7 illustrates a distribution of 64-bit random samples with respect to their 1s counts.

FIG. 8 illustrates an example of hashing circuitry that may be implemented according to various embodiments of the disclosed technology.

FIG. 9 illustrates an example of a true random number generator combined with hashing circuitry that may be implemented according to various embodiments of the disclosed technology.

FIG. 10 illustrates an example of a hardware-root-of-trust system that may be implemented according to various embodiments of the disclosed technology.

FIG. 11 illustrates an example descrambler that may be implemented according to various embodiments of the disclosed technology.

FIG. 12 illustrates an example of a controller that may be implemented according to various embodiments of the disclosed technology.

FIG. 13 illustrates an example of applying three different test patterns to an inverter-based ring oscillator.

FIG. 14 illustrates an example hardware root of trust capable of self-testing that could be implemented according to various embodiments of the disclosed technology.

FIG. 15 illustrates an example of a programmable computer system with which various embodiments of the disclosed technology may be employed.

### DETAILED DESCRIPTION OF THE DISCLOSED TECHNIQUES

Various aspects of the disclosed technology relate to ring-generator-based true random number generators and hardware root of trust circuits constructed based on them. In the following description, numerous details are set forth for the purpose of explanation. However, one of ordinary skill in the art will realize that the disclosed technology may be practiced without the use of these specific details. In other instances, well-known features have not been described in details to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

The detailed description of a method or a device sometimes uses terms like “configure” and “inject” to describe the disclosed method or the device function/structure. Such terms are high-level descriptions. The actual operations or functions/structures that correspond to these terms will vary depending on the particular implementation and are readily discernible by one of ordinary skill in the art.

As used in this disclosure, the singular forms “a,” “an,” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements not affecting the intended operation of the circuit.

Additionally, as used herein, the term “design” is intended to encompass data describing an entire integrated circuit device. This term also is intended to encompass a smaller group of data describing one or more components of an entire device such as a portion of an integrated circuit device nevertheless.

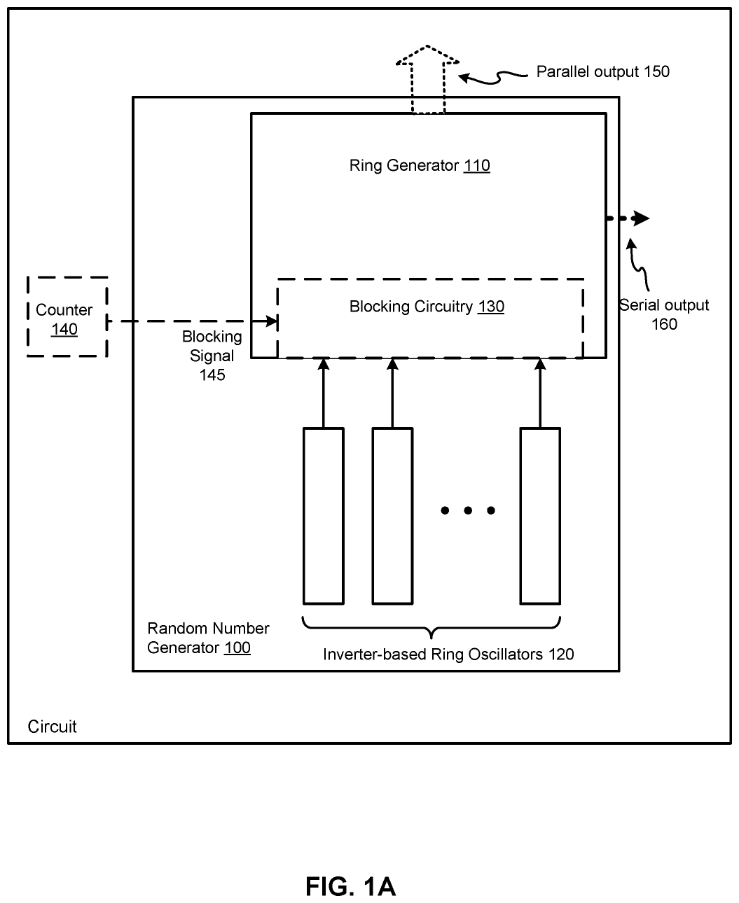

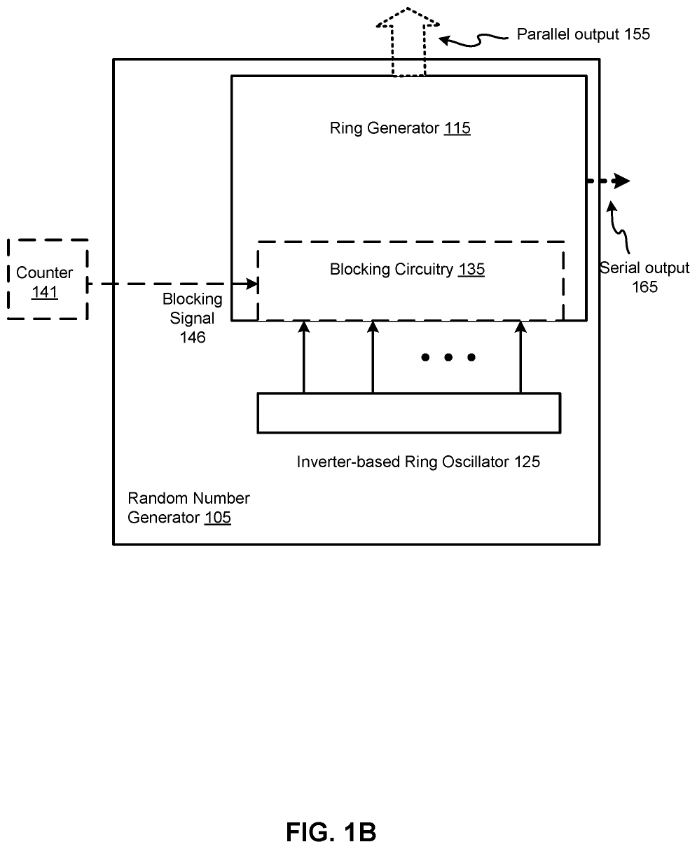

As noted previously, true random number generators are one of the important hardware security primitives for hardware root of trust. It is preferable that a true random number generator can be easily synthesized by using digital components. FIG. 1A illustrates an example of a true random number generator 100 that may be implemented according to various embodiments of the disclosed technology. The true random number generator 100 comprises a ring generator 110 and a plurality of inverter-based ring oscillators 120. Both the ring generator 110 and the plurality of inverter-based ring oscillators 120 can be constructed using digital components. Each of the plurality of inverter-based ring oscillators 120 is configured to inject bits into the ring generator 110 at a unique location. With various implementations of the disclosed technology, each of the plurality of inverter-based ring oscillators 120 may comprise a unique number of inverting elements (inverting devices). Examples of the inverting elements are NOT gates and NAND gates.

FIG. 1B illustrates an example of a true random number generator 105 that may be implemented according to various embodiments of the disclosed technology. The true random number generator 105 comprises a ring generator 115 and an inverter-based ring oscillator 125. Both the ring generator 115 and the inverter-based ring oscillator 125 can be constructed using digital components. The inverter-based ring oscillator 125 is configured to inject bits into the ring generator 115 at multiple locations from outputs of multiple selected inverting elements in the inverter-based ring oscillator 125.

It should be noted that the schemes shown in FIGS. 1A and 1B can be combined. For example, a true random number generator can comprise a ring generator and two inverter-based ring oscillators. Each or one of the inverter-based ring oscillators injects bits into the ring generator at multiple locations.

Ring generators are a type of linear finite state machines, which can be derived by altering the canonical forms (external feedback, internal feedback) of linear feedback shift registers while maintaining their transition functions. An example of the altering is the m-sequence preserving transformations described in G. Mrugalski, J. Rajski, J. Tyszer, “Ring Generators—New Devices for Embedded Test Applications,” IEEE Trans. Computer-Aided Design, vol. 23, no. 9, pp. 1306-1320, 2004. Like linear feedback shift registers, ring generators can be used in various circuit test applications such as pseudorandom test pattern generation, on-chip test data decompression, and test response compaction. It has been shown that after applying the transformations to linear feedback shift registers in a certain order, the resultant ring generators feature a significantly reduced number of levels of XOR logic, minimized internal fan-outs, and simplified circuit layout and routing, as compared to conventional linear feedback shift registers and cellular automata. Consequently, ring generators have highly modular structures and can operate at high speeds.

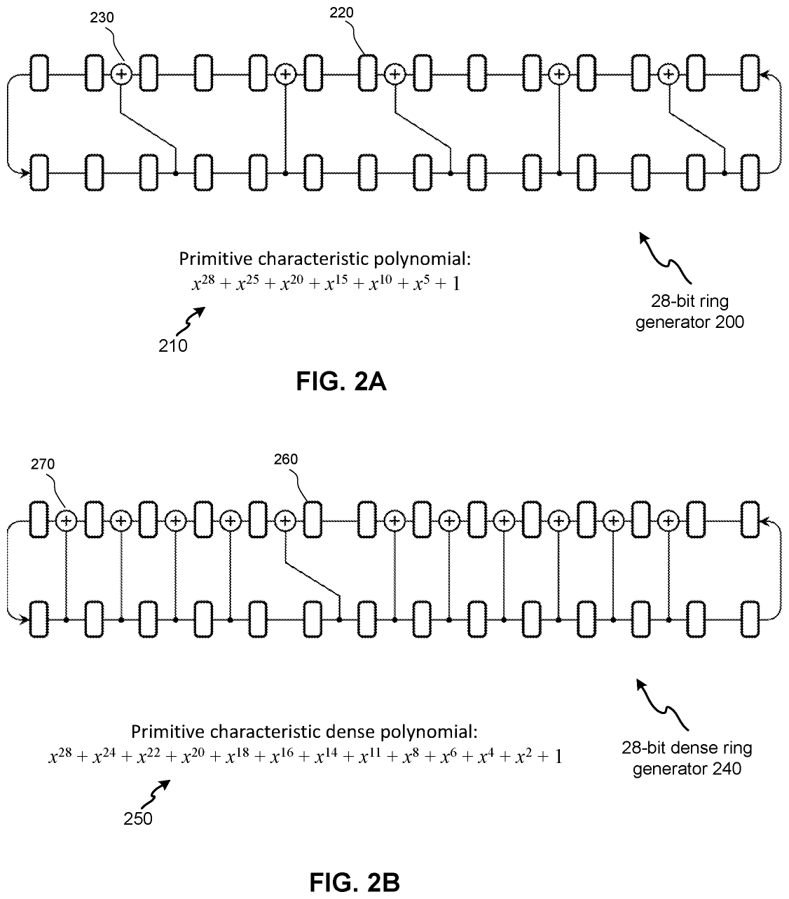

FIG. 2A illustrates an example of a 28-bit ring generator 200 implementing a primitive characteristic polynomial 210. The 28-bit ring generator 200 comprises twenty-eight state elements 220 and five XOR gates 230. Each of the XOR gates 230 is located at a feedback location in a ring formed by the state elements 220 and one of its input is connected to a feedback tap via a feedback line. The state elements 220 can be implemented using flip-flops. As the figure shows, the feedback logic for the 28-bit ring generator 200 has only one two-input XOR gate per feedback line, so the number of levels of logic is 1, smaller than 2 and log₂k for a cellular automaton and the external feedback form of linear feedback shift registers (k is the number of XOR gates), respectively. Also as indicated by the figure, the 28-bit ring generator 200 does not use long feedback lines which are needed in the internal feedback form of linear feedback shift registers. Therefore, ring generators are faster than both the two canonical forms of linear feedback shift registers and cellular automata.

FIG. 2B illustrates an example of a 28-bit dense ring generator 240 implementing a primitive characteristic polynomial 250. The 28-bit dense ring generator 240 comprises twenty-eight state elements 260 and eleven XOR gates 270. The large number of XOR gates 270 leads to the dense characteristic polynomial 250 which has thirteen non-zero terms, compared to seven non-zero terms of the primitive characteristic polynomial 210. Dense ring generators, when used for test data decompression, are capable of driving a large number of scan chains by using either outputs taken directly from the feedback logic or phase shifters that are tapped locally from consecutive locations. This can allow designers to minimize routing complexity, optimize wire sizing, and make the overall layout compact. It should be noted that either conventional ring generators like the 28-bit ring generator 200 or dense ring generators like the 28-bit dense ring generator 240 can be used to implement the ring generator 110 in FIG. 1A and the ring generator 115 in FIG. 1B.

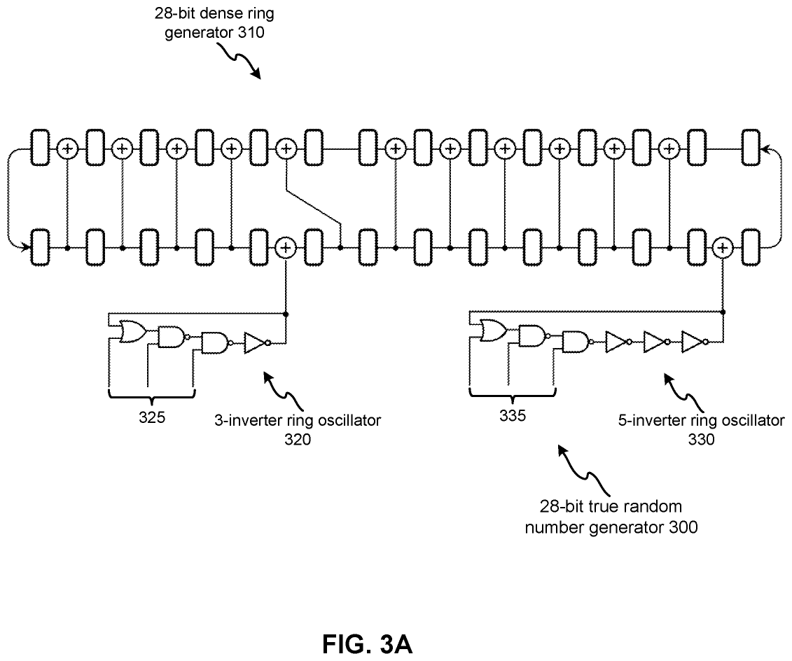

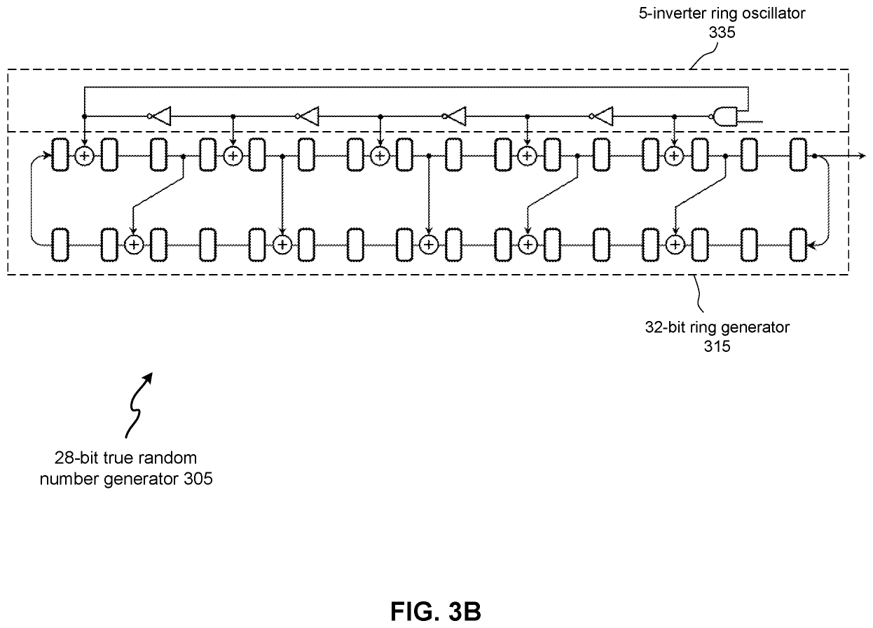

FIG. 3A illustrates an example 28-bit true random number generator 300 based on a 28-bit dense ring generator 310 that may be implemented according to various embodiments of the disclosed technology. The 28-bit dense ring generator 310 is the same as the 28-bit dense ring generator 240 in FIG. 2B. In addition to the 28-bit dense ring generator 310, the 28-bit true random number generator 300 comprises a 3-inverter ring oscillator 320 and a 5-inverter ring oscillator 330. The 3-inverter ring oscillator 320 and the 5-inverter ring oscillator 330 can inject bits into the 28-bit dense ring generator 310 through XOR gates at two different locations, respectively. Different numbers of inverting elements may enhance randomness of the generated sequences of random numbers. Input 325 for the 3-inverter ring oscillator 320 and inputs 335 for the 5-inverter ring oscillator 330 can be used to apply test stimuli for testing these ring oscillators, which will be discussed in detail later.

FIG. 3B illustrates an example 32-bit true random number generator 305 based on a 32-bit ring generator 315 that may be implemented according to various embodiments of the disclosed technology. In addition to the 32-bit ring generator 315, the 32-bit true random number generator 305 comprises a 5-inverter ring oscillator 335. The outputs of five inverting elements (four inverters and one NAND gate) of the 5-inverter ring oscillator 335 can inject bits into the 32-bit ring generator 315 through XOR gates at five different locations, respectively. It should be noted that in some embodiments of the disclosed technology, not all outputs of the inverting elements are used for injecting bits into the ring generator.

Referring back to FIG. 1A, the ring generator 110, as described above, can produce a sequence of pseudorandom numbers by itself. The injections from the plurality of inverter-based ring oscillators 120 transform the ring generator 110 into a true random number generator. Each of the plurality of inverter-based ring oscillators 120 injects the logic value of 1 into the ring generator 110 with a frequency that depends on the integrated circuit fabrication process and the number of inverting elements used. The stochastic characteristics present in the integrated circuit fabrication process thus supplies desired uncertainty (entropy) or randomness. Further, since the clocking of the ring generator 110 is inherently asynchronous to the state of every ring oscillator 120, many clock samples may also stress the metastable region of the flip-flops of the ring generator 110 (due to setup and hold time violations), thereby producing additional randomness.

Referring back to FIG. 1B, the inverter-based ring oscillator 125 operates with a frequency that depends on the circuit fabrication process, the number of logic elements it deploys, and the delay of its routing path. Sampling many inverters can populate a relatively long interval with the timing jitter, hence maximizing the probability that at least one noisy signal edge is captured in the ring generator 115. Consequently, the ring generator 115 acts as a special form of a bit extractor processing data collected at several stages of the inverter-based ring oscillator 125. Furthermore, since the clocking of the ring generator 115 is inherently asynchronous to the state of the inverter-based ring oscillator 125, some clock samples may stress the metastability region of the ring generator flip-flops (due to setup and hold time violations), thereby producing an additional uncertainty (entropy) or randomness.

The performance of both the true random number generator 100 in FIG. 1A and the true random number generator 105 in FIG. 1B can be experimentally tested.

In FIG. 1A, the true random number generator 100 may further comprise blocking circuitry 130 configured to convert, based on a blocking signal 145, the ring generator 110 into a circular shift register by blocking both the injection from the plurality of inverter-based ring oscillators 120 and internal feedbacks in the ring generator 110. The blocking signal 145 can be configured to change from unblocking to blocking when the content of the ring generator 110 is ready to be sent out. Typically, the change occurs after a predefined number of clock cycles dictated by a counter 140. The counter 140 can be inside or outside a controller. The content of the ring generator 110 can be sent out via a serial output 160, a parallel output 150, or both.

Similarly, in FIG. 1B, the true random number generator 105 may further comprise blocking circuitry 135 configured to convert, based on a blocking signal 146, the ring generator 115 into a circular shift register by blocking both the injection from the inverter-based ring oscillator 125 and internal feedbacks in the ring generator 115. The counter 141 can supply the blocking signal 146. The counter 141 can be inside or outside a controller. The content of the ring generator 115 can be sent out via a serial output 165, a parallel output 155, or both.

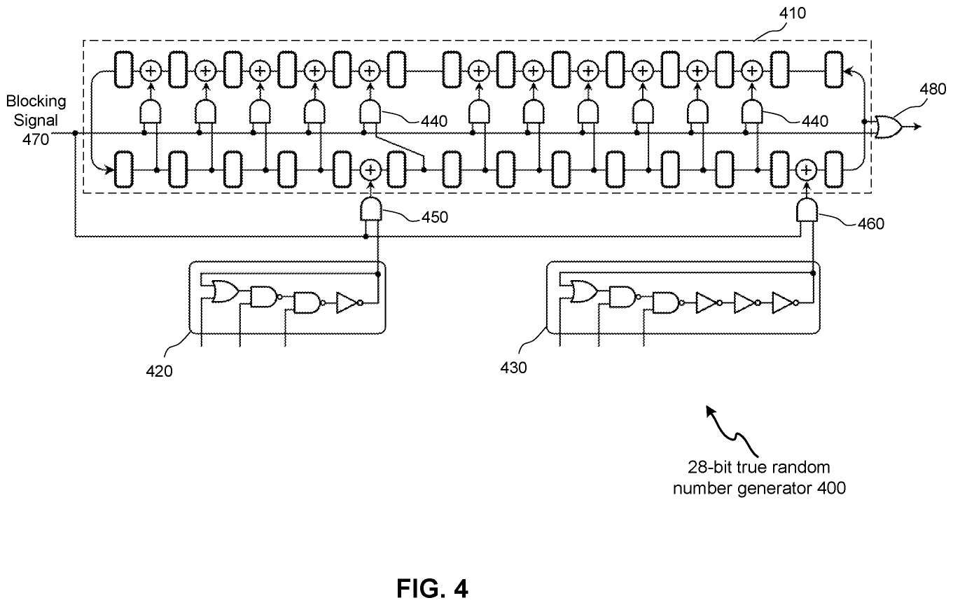

FIG. 4 illustrates an example 28-bit true random number generator 400 having built-in block circuitry that may be implemented according to various embodiments of the disclosed technology. Like the 28-bit true random number generator 300 in FIG. 3A, the 28-bit true random number generator 400 comprises a 28-bit dense ring generator 410, a 3-inverter ring oscillator 420, and a 5-inverter ring oscillator 430. Further, the 28-bit true random number generator 400 comprises eleven AND gates 440, one on each of the feedback lines of the 28-bit dense ring generator 410, an AND gate 450 gating the output of the 3-inverter ring oscillator 420, and an AND gate 460 gating the output of the 5-inverter ring oscillator 430. These AND gates 440, 450 and 460 form the block circuitry and are controlled by a blocking signal 470. When the blocking signal 470 is “1”, the 28-bit dense ring generator 410 operates as a ring generator with injections from the 3-inverter ring oscillator 420 and the 5-inverter ring oscillator 430. When the blocking signal 470 is changed to “0”, the 28-bit dense ring generator 410 becomes a circular shift register and its content can be shifted out through an OR gate 480. Some outputs of the state elements of the 28-bit dense ring generator 410 can be configured to serve as the parallel output of the 28-bit true random number generator 400.

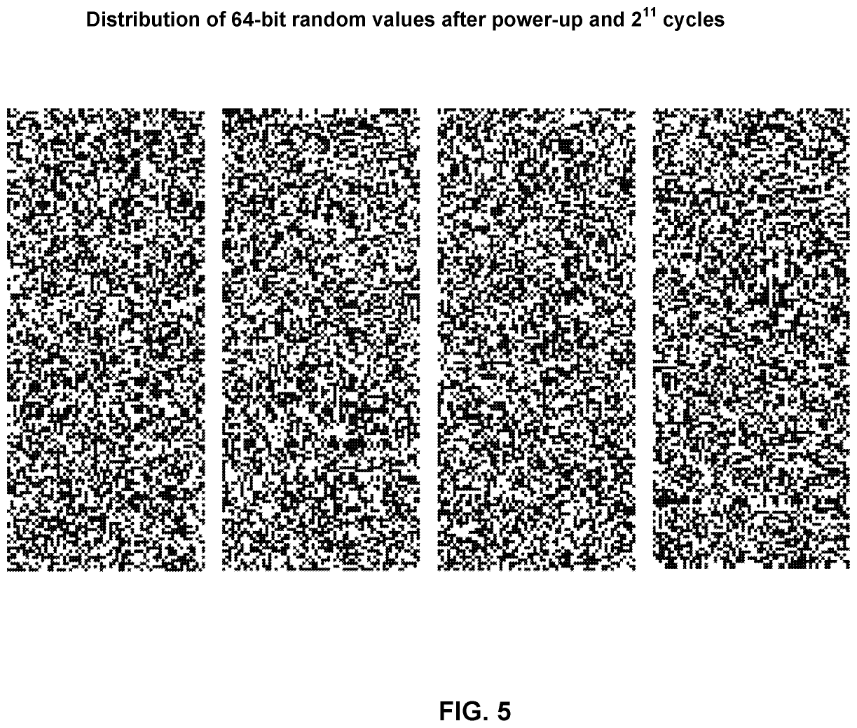

FIG. 5 illustrates an example distribution of 0s and 1s obtained for a 64-bit true random number generator. The 64-bit true random number generator comprises a 64-bit dense ring generator which implements a primitive characteristic polynomial h (x)=x⁶⁴+x⁶²+x⁶⁰+x⁵⁸+x⁵⁶+x⁵⁴+x⁵²+x⁵⁰+x⁴⁸+x⁴⁶+x⁴⁴+x⁴²+x⁴⁰+x³⁸+x³⁶+x³⁴+x³²+x³⁰+x²⁸+x²⁶+x²³+x²⁰+x¹⁸+x¹⁶+x¹⁴+x¹²+x¹⁰+x⁸+x⁶+x⁴+1 and four ring oscillators comprising 3, 5, 7 and 11 inverters as injectors, respectively. The injection locations are distributed every 8 flip-flops in the upper level of the ring generator. This 64-bit true random number generator can be constructed using the Xilinx Artix-7 FPGAs on the Cmod A7-15tboard having a port that facilitates collection of true random numbers. The circuit is powered up 100,000 times and the resultant values are scanned out after 211 clock cycles (FIG. 5 illustrates the first 768 random samples obtained this way) for further inspection.

An ideal true random number generator yields independent random combinations as otherwise its behavior can be easily predicted. In particular, one can measure a correlation between any pair of bits across all sampled random outputs, effectively collecting n(n−1)/2 correlation coefficients, where n is the true random number generator size. Given s successive samples, the correlation coefficient

$${ρ}_{i , k} = {s}^{- 1} \sum ( {b}_{i} - 0.5 ) ( {b}_{k} - 0.5 ) \qquad ( 1 )$$

between bits b, and bx should be close to 0 to confirm that there is no strong, discernible, and systematic relation between these two positions.

Random numbers produced by 64-, 128-, and 256-bit true random number generators are tested, taking 100,000 samples in each case. It turns out that the average (absolute) correlation value for the 64-bit true random number generator over all (64×63)/2=2,016 combinations of bits is 0.002611, with the minimal and maximal values being equal to ρ_{5.41}=0.00001 and ρ_{7.55}=0.0127, respectively. In fact, none of the recorded coefficients was significantly different from 0 in comparison with the N(0,1) distribution, at level α=0.01 (or smaller), thus indicating that the produced samples do not exhibit observable correlation between any pair of their bits. Similar results are obtained for the other true random number generators.

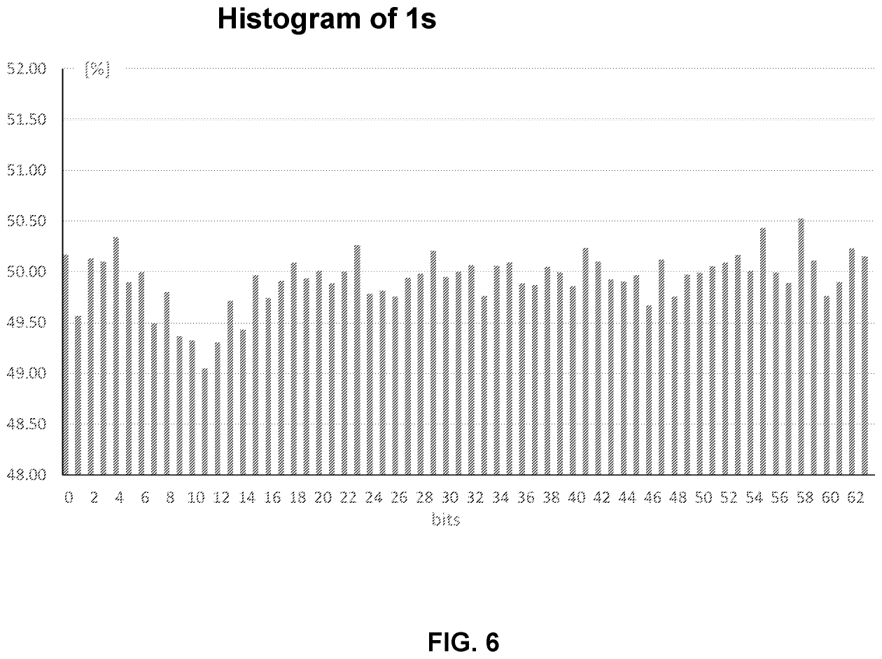

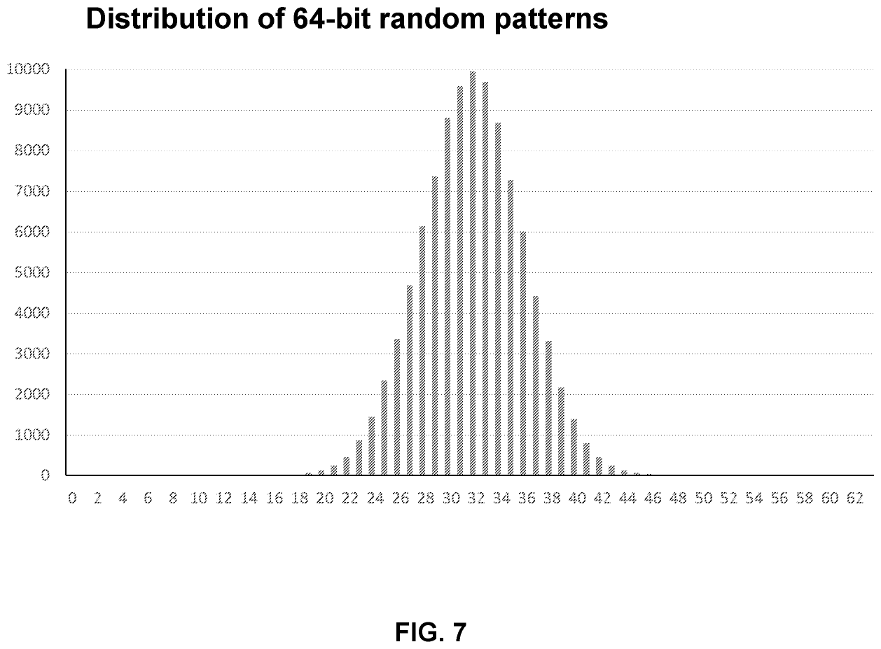

Whether the logic value of 1 occurs on every bit position roughly half of the time may also be used to validate the feasibility of the disclosed true random number generator. It is desirable that the number of 1s occurring on every bit in the produced s samples have a symmetric binomial distribution with the mean value of s·p, where p=0.5. This can be easily verified by, for instance, the chi-square test. The histogram of 1s observed on successive bits of the 64-bit-true-random-number-generator-produced numbers is shown in FIG. 6. Similarly, the number of n-bit sequences comprising k 0s and n−k 1s is binomially distributed, as illustrated in FIG. 7. Again, the goodness-of-fit hypothesis test are used to validate this observation.

High passing rates for running statistical tests from NIST-SP800-22, NIST-SP800-90B, and AIS31 suites have also been obtained for 64-, 128-, and 256-bit true random number generators. These tests are described in L. Bassham et al., “A statistical test suite for random and pseudorandom number generators for cryptographic applications,” NIST Special Publication, Tech. Rep. 800-22 Rev la, 2010 and W. Killmann and W. Schindler, “AIS 31: Functionality classes and evaluation methodology for true (physical) random number generators, version 3.1,” in Proc. Bundesamt Sicherheit der Informationstechnik (BSI), Bonn, Germany, 2001, pp. 1-9, respectively.

A true random number generator can be combined with hashing circuitry to serve as components of hardware root of trust. On the secured server side, a processor can use a hash function to compute a hash value from a nonce produced by a circuit. The hash value can serve as or be used to generate a response to the nonce. On the circuit side, hashing circuitry can mimic the hashing function to transform the nonce into the same hash value as the one computed by the processor. The circuit can then use the response and the on-chip-generated hash value to perform security-related tasks.

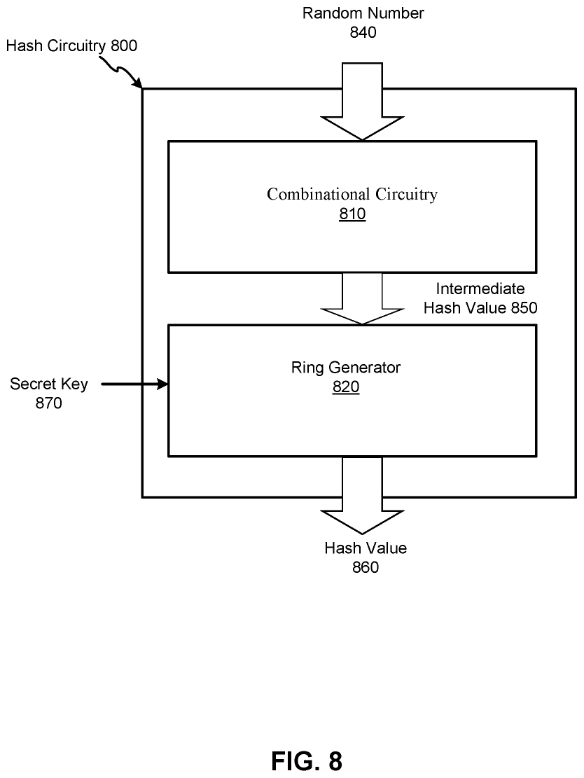

FIG. 8 illustrates an example of hashing circuitry 800 that may be implemented according to various embodiments of the disclosed technology. The hashing circuitry 800 comprises combinational circuitry 810 and a ring generator 820. The combinational circuitry 810 comprises logic gates and can be taken from a class of hash functions. Each member of the class comprises a number of nonlinear Boolean operators as well as simple logic functions in their canonical forms. Selection of a particular hash function can be decided on the basis of the size of random number 840 and the ring generator 820. The combinational circuitry 810 can transform the random number 840 into an intermediate hash value 850. The ring generator 820 can mutate the intermediate hash value 850 and transform it into a hash value 860. During a hashing process, the ring generator 820 is first initialized by a secret key 870. The secret key 870 may be stored in an encoded form in a nonvolatile on-chip tamper-proof memory. The secret key 870 can be serially uploaded into the ring generator 820 prior to the actual hashing clock cycles. After the initialization, bits of the intermediate hash value 850 are injected into the ring generator 820 from outputs of the combinational circuitry 810. During the injection process, several bits of the intermediate hash value 850 are continuously available at the outputs of the combinational circuitry 810. After a predefined number of clock cycles that suffice to rotate the content of the ring generator 820 multiple times, the hash value 860 is finalized and ready to be used for subsequent applications. The ring generator 810 can be implemented by using either conventional ring generators like the 28-bit ring generator 200 in FIG. 2A or dense ring generators like the 28-bit dense ring generator 240 in FIG. 2B.

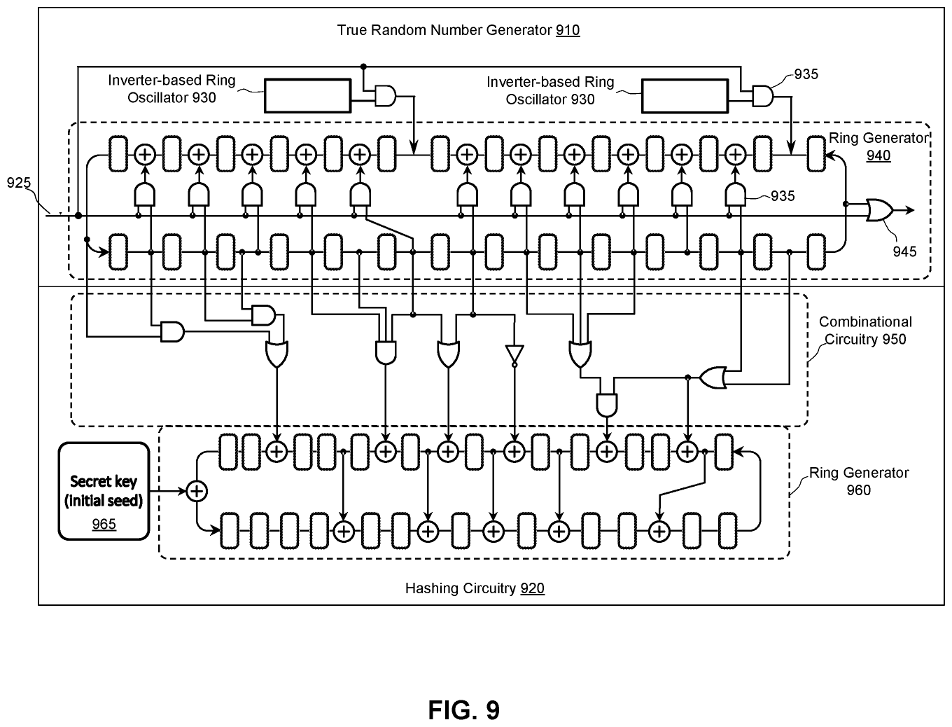

FIG. 9 illustrates an example of a true random number generator 910 combined with hashing circuitry 920 that may be implemented according to various embodiments of the disclosed technology. The true random number generator 910 comprises a ring generator 940, two inverter-based ring oscillators 930, blocking circuitry formed with thirteen AND gates 735, and an OR gate 945 configured to control a serial output of the true random number generator 910. The ring generator 940 is a 28-bit dense ring generator, similar to the 28-bit dense ring generator 240 in FIG. 2B. The two inverter-based ring oscillators 930 may be implemented by two ring oscillators having different numbers of inverting elements such as the 3-inverter ring oscillator 420 and the 5-inverter ring oscillator 430 shown in FIG. 4.

When a blocking signal 925 is changed to the logic value of zero, the AND gates 935 transforms the ring generator 940 into a circular shift register by blocking both the injection from the inverter-based ring oscillators 930 and internal feedbacks in the ring generator 940. Typically, the change occurs after a predefined number of clock cycles which can be controlled by a counter (not shown in the figure). The blocking signal 935 can also control the serial output of the true random number generator 910 via the OR gate 945. The serial output can be used to form a nonce which is sent to a security server outside the chip.

The hashing circuitry 920 comprises combinational circuitry 950 and a ring generator 960. The combinational circuitry 950 comprises AND gates, OR gates, and an inverter, and has 13 inputs and 6 outputs. The combinational circuitry 950 is configured to use bits outputted from the ring generator 940 to produce an intermediate hash value after the blocking signal 935 transforms the ring generator 940 into a circular shift register. The transformation spans over several stages of this circular shift register. The final hash value is formed by the ring generator 960. As discussed previously, a secret key 965 is used to initialize the ring generator 960 prior to the actual hashing clock cycles, and the ring generator 960 can then mutate the intermediate hash value based on a primitive feedback polynomial it employs. The hashing process performed in the ring generator 960 comprises injecting several bits that are continuously available at the six outputs of the combinational circuitry 950 and rotating the content of the ring generator 960 multiple times. This can be controlled by a counter which is not shown in FIG. 9. This counter can be the same counter used to control the change of the blocking signal 925. It should be noted that there may be other control circuitry in addition to the counter, of which some components may be placed between and/or within each of the true random number generator 910 and the hashing circuitry 920.

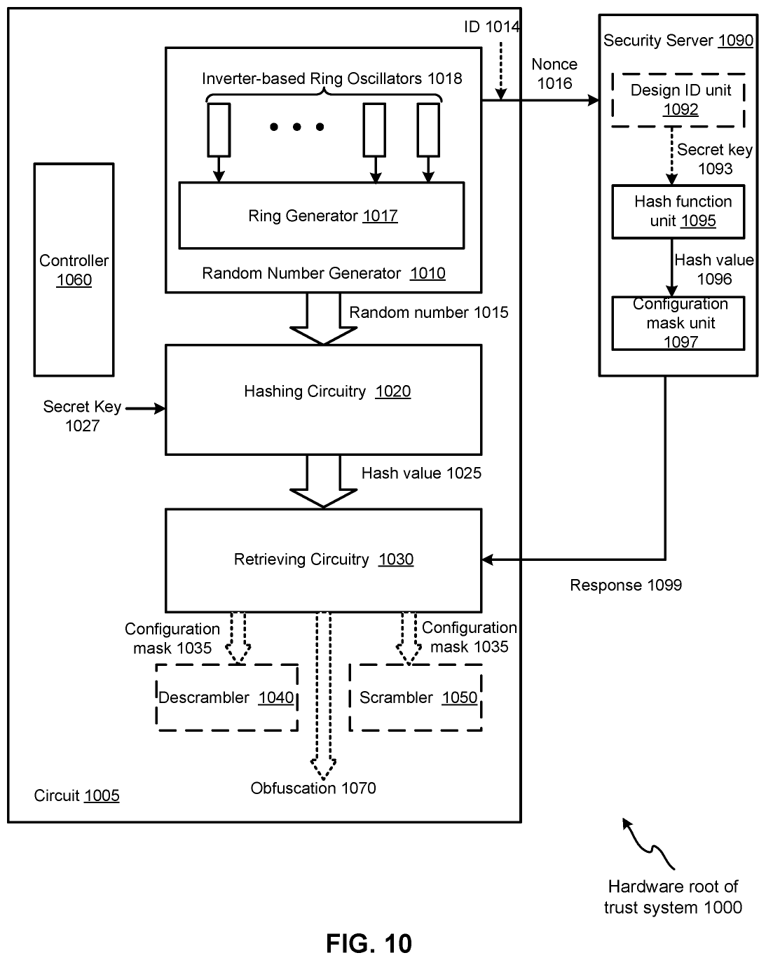

FIG. 10 illustrates an example of a hardware-root-of-trust system 1000 that may be implemented according to various embodiments of the disclosed technology. The hardware-root-of-trust system 1000 comprises components in both a circuit 1005 and a security server 1090. The components in the circuit 1005 comprises a random number generator 1010, hashing circuitry 1020, retrieving circuitry 1030, and a controller 1060. The components in the security server 1090 comprises a hash function unit 1095 and a configuration mask unit 1097.

The random number generator 1010 can be prompted to generate a random number 1015. A request received by the circuit 1005 to run a certain function, for example, can be set to cause such an action. The circuit 1005 then sends to the security server 1090 a nonce 1016 formed based on the random number 1015. The nonce 1016 may contain only the random number 1015 or may further contain some individual data from the circuit 1005 such as its electronic design identification number 1014. The random number generator 1010 comprises a ring generator 1017 and one or more inverter-based ring oscillators 1018. It should be noted that while the random number generator 1010 is shown to be similar to the true random number generator 100 in FIG. 1A, the true random number generator 105 in FIG. 1B or a mixed of the two can be used to implement the random number generator 1010.

The hashing circuitry 1020 can be implemented using the hashing circuitry 800 in FIG. 8 according to various embodiments of the disclosed technology. Like the hashing circuitry 800 in FIG. 8, the hashing circuitry 1020 can comprise combinational circuitry and a ring generator. The combinational circuitry can transform the random number 1015 into an intermediate hash value. The ring generator can then transform the intermediate hash value into a hash value 1025. The overall hash function which the hashing circuitry 1020 is configured to mimic the same hash function employed by the hash function unit 1095 in the security server 1090.

The hash function unit 1095 use the hash function to compute a hash value 1096 for the received nonce 1016. In normal operations, the hash value 1096 should be the same as the hash value 1025. The computation may involve a secret key 1093 that is used as an initial value for hashing the random number 1015 included in the nonce 1016. The security server 1090 may further comprise a design identification (Design ID) unit 1092. The design identification unit 1092 can verify the electronic design identification number 1014 and based on it, retrieve the secret key 1093 to be used by the hash function unit 1095. If the electronic design identification number 1014 is invalid, the security server 1090 may still generate a unique and fake initial hash value and use it to obfuscate the resultant response. The security server 1090 may also keep track of how many times each individual chip requested a response, monitoring any unusual behavior. The same (valid) secret key 1027 can be kept in an encrypted form by the circuit 1005 and used by the hashing circuitry 1020 in a way similar to how the hash function unit 1095 uses the secret key 1093.

The configuration mask unit 1097 in the security server 1090 can combine the hash value 1096 with one or more configuration masks to generate a response 1099. One example of the configuration masks is a configuration mask that can be employed for descrambling encrypted data into original data. Another example is a configuration mask that can be employed for scrambling original data into encrypted data. With various implementations of the disclosed technology, the configuration mask unit 1097 can perform a bit-wise XOR operation combining bits of the one or more configuration masks with bits of the hash value 1096. In addition to the one or more configuration masks, other items may also be XORed with the hash value 1096. Alternatively or additionally, some bits of the hash value 1096 may be left unchanged.

After the circuit 1005 receives the response 1099 from the security server 1090, the retrieving circuitry 1030 can use the hash value 1025 received from the hashing circuitry 1020 to retrieve the one or more configuration masks 1035 from the response 1099. If the one or more configuration masks 1035 are XORed with the hash value 1096 in a bitwise operation by the configuration mask unit 1097 as described above, the retrieving circuitry 1030 can use XOR gates to perform a bitwise retrieving operation.

The circuit 1005 may further comprise a descrambler 1040, a scrambler 1050, or both. The descrambler 1040 can use one of the one or more configuration masks 1035 to retrieve original data from encrypted data received by the circuit 1005. For example, the descrambler 1040 can be configured to retrieve compressed test patterns from encrypted compressed test patterns received by the circuit 1005. The scrambler 1050 can use another one of the one or more configuration masks 1035 to encrypt data that need to be sent out by the circuit 1005. For example, the scrambler 1050 can be configured to encrypt test responses or compacted test response before they are sent out by the circuit 1005 for analysis.

An attempt to unauthorized access may trigger twofold changes in the circuit internal functionality if both the descrambler 1040 and the scrambler 1050 are in the circuit 1005. First, the descrambler 1040 and the scrambler 1050 become blurred due to corrupted configuration masks. Second, the remaining bits (obfuscation 1070) of the response 1099 if any can be used to hide design functionality from adversaries in the process of logic obfuscation. The logic obfuscation can result in signal corruptions caused by activation of certain elements. Alternatively, any mismatch between some bits of the hash value 1025 and the hash value 1096 may launch a simple logic locking scheme, disabling access to the genuine functionality of the circuit 1005.

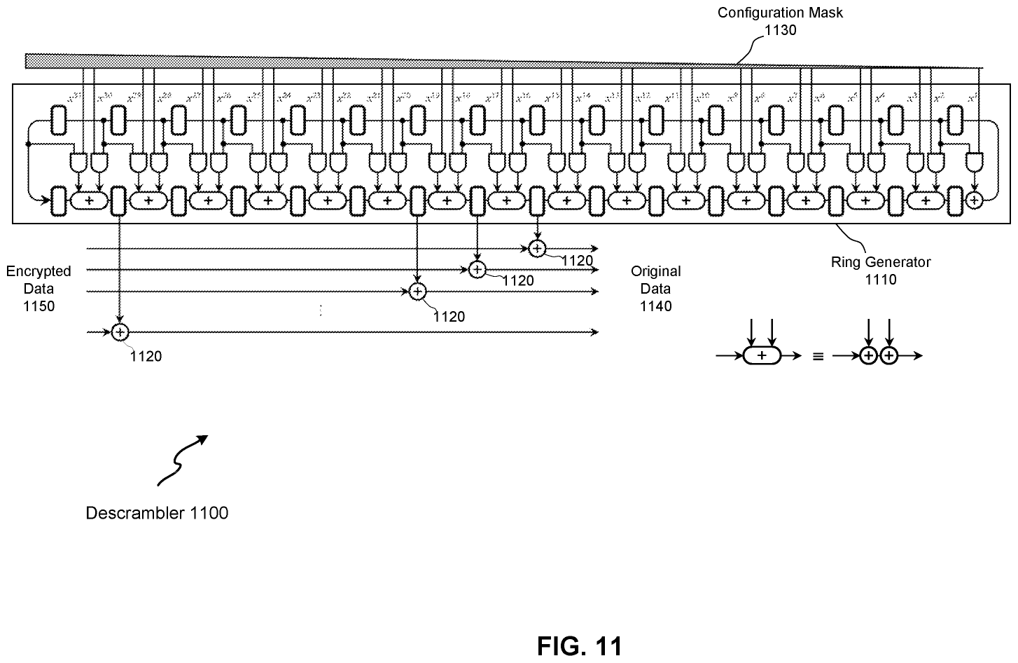

FIG. 11 illustrates an example descrambler 1100 that may be implemented according to various embodiments of the disclosed technology. The descrambler 1100 comprises a 32-bit ring generator 1110 and XOR gates 1120 and uses the principle of the Vernam stream cipher. Bits of a configuration mask 1130 are injected into the 32-bit ring generator 1110 through its feedback lines. The XOR gates 1120 use the pseudorandom sequences produced by the 32-bit ring generator 1110 to retrieve original data 1140 from encrypted data 1150. As discussed previously, a ring generator can operate at a high speed, enabling a ring-generator-based descrambler to work with other high-speed circuitry in the circuit. Further, the modular and programmable feedback network properties of a ring generator allow various characteristic polynomials to be implemented. This, in turn, allows one to pick a suitable secret configuration mask that may correspond to a primitive polynomial depending on other security needs.

A scrambler can use the same principles described above. A configuration mask for scrambling is injected into a ring generator in the same way as the configuration mask 1130. Bits of the data to be scrambled are XORed with bits of the pseudorandom sequences produced by the ring generator. For scrambling, the locations for the encrypted data 1150 and the original data 1140 are switched.

An attempt to unauthorized access is detected when the response from the security server does not match what is expected. The detection can lead to a wrong descrambling mask. The wrong descrambling mask can trigger a peculiar feedback polynomial that is going to yield a pseudorandom sequence (even not necessarily a maximum-length on its own) that can effectively blur encrypted input data. The scrambler can obscure output data following the same principles.

Referring back to FIG. 10, the security components in the circuit 1005 such as the random number generator 1010, the hashing circuitry 1020, and/or the retrieving circuitry 1030 can be controlled by the controller 1060. The controller 1060 can be implemented using a simple finite-state machine. As discussed previously, the ring generator 1017 needs a preset number of clock cycles before it is ready to output the random number 1015. The hashing circuitry 1020 can be implemented using hashing circuitry 800 in FIG. 8. It would also needs at least a certain number of clock cycles that suffice to rotate the content of the ring generator 820 multiple times before the hash value 1025 is finalized and ready to be used for subsequent applications. Accordingly, the controller 1060 can include a counter to determine the time needed in the operations of the random number generator 1010 and the hashing circuitry 1020. In addition to the finite-state machine and the counter, the controller 1060 can comprise other components for additional functions such as self-testing.

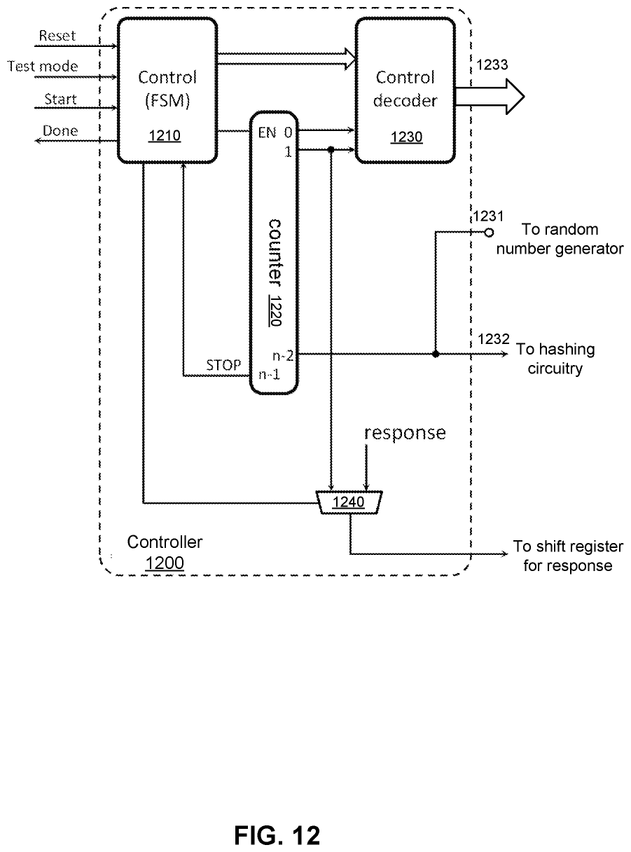

FIG. 12 illustrates an example of a controller 1200 that may be implemented according to various embodiments of the disclosed technology. The controller 1200 comprises a control unit 1210, a counter 1220, a control decoder 1230, and a multiplexer 1240. The control unit 1210 can be implemented using a finite-state machine circuit (FSM). The counter 1230 can control, through outputs 1231 and 1232, respectively, activity periods of both the random number generator and the hashing circuitry. The counter 1230 can also signal the control unit 1210 when its most significant output bit changes from 0 to 1, which can be used to terminate operations. The multiplexer 1240 and the control decoder 1230 can be used for self-testing, which will be discussed below.

It is desirable that security components of a hardware root of trust system can be tested in an autonomous process that relies either entirely or in large part on internal on-chip resources that do not interfere with other circuit testing components. Since logic built-in self-test (LBIST) provides neither full observability nor full controllability of internal storage elements from the circuit interface, it can be used to test components of a hardware root of trust system while thwarting potential Boolean satisfiability (SAT)-based attacks and making scan-based attacks unfeasible.

In logic built-in self-test, the original circuit is typically appended with additional modules designed for generation of test patterns and compaction of test responses. The hardware root of trust that is implemented according to various embodiments of the disclosed technology, however, can facilitate self-testing based on existing blocks due to its simplicity and inherent iterative functionality. In the hardware-root-of-trust system 1000 in FIG. 10, the true random number generator 1018 can be repurposed during self-testing to be used as a pseudorandom test pattern generator by disabling the feedback loops of the inverter-based ring oscillators 1018. Pseudorandom data and possible errors can easily propagate through the hash circuitry 1020 due to its original functionality. One of the counter outputs in the controller 1060 can be reused to provide test stimuli (001100110011 . . . ) for testing a shift register that is typically employed to store the response 1099 before being processed by the retrieving circuitry 1030. The shift register may be a component of the retrieving circuitry 1030.

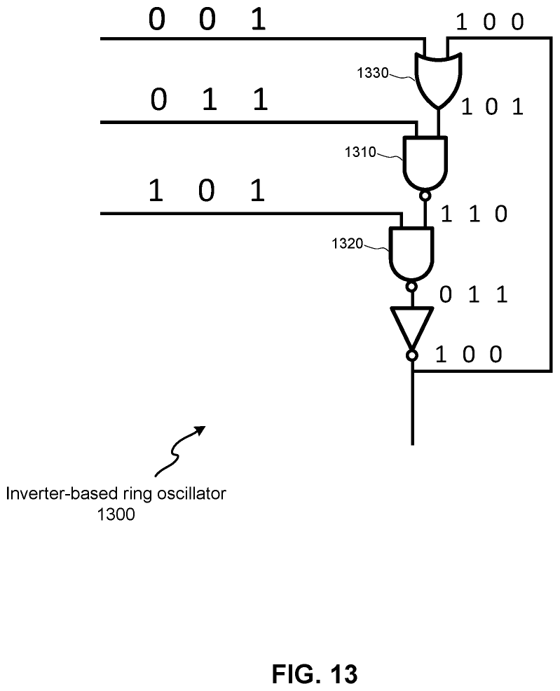

The inverter-based ring oscillators 1018 can be tested by breaking their own feedback loops and applies multiple times different patterns to detect stuck-at faults within the inverter-based ring oscillators 1018 and to inject into the ring generator 1017 with deterministic data. FIG. 13 illustrates an example of applying three different test patterns to an inverter-based ring oscillator 1300. It is worth noting that all nets in the inverter-based ring oscillator 1300 can assume both values: 0 and 1 during a test. It allows to excite all stuck-at-1 and stuck-at-0 faults, respectively. The first pattern (001) disables the feedback loop at a gate 1310, whereas the second pattern (010) does the same at a gate 1320. The last vector (111) blocks the loop at an auxiliary OR gate 1330 that allows to detect and observe faults on the feedback net (and thus on the input of the gate 1310). The output of the OR gate 1330 can be directly connected to an observation point to observe responses related to faults affecting the feedback line as well as the stuck-at-1 fault on the input of the gate 1310 (note that these faults cannot propagate to the oscillator output due to dominating signals assigned to the inputs of the gates 1310 and 1320).

The test patterns for testing the inverter-based ring oscillators 1018 in FIG. 10 can be supplied by a control decoder in the controller 1060, just like the control decoder 1230 in the controller 1200 in FIG. 12. As FIG. 12 shows, based on signals from the control unit 12010 and the counter 1202, the control decoder 1230 can provide test patterns to stimulate the inverter-based ring oscillators via outputs 1233. If one of the outputs (driving, for example, the gates 1310-1330, respectively in FIG. 13) is stuck at the non-controlling value, and this fault causes one of these inputs to change from a dominating value to a non-controlling one, then the inverter-based ring oscillator will oscillate, effectively producing a sequence of erroneous values entering the random number generator.

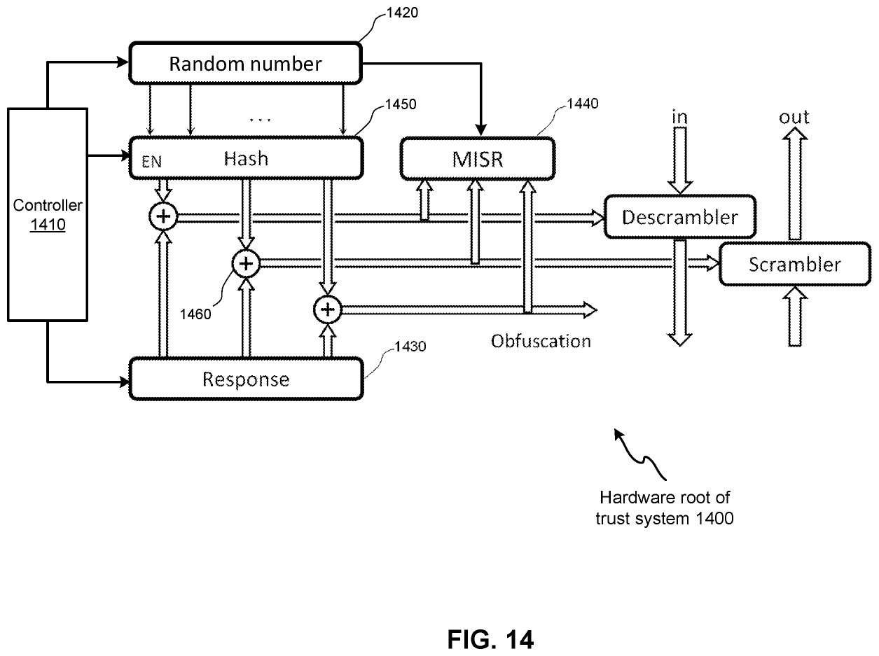

Finally, a multiple-input signature register (MISR) can be added for compacting test response. The test response outputs from both the inverter-based ring oscillators 1018 and the retrieving circuitry 1030 can be coupled to the multiple-input signature register to produce a final signature of test responses. FIG. 14 illustrates an example hardware root of trust 1400 capable of self-testing that could be implemented according to various embodiments of the disclosed technology. A controller 1410 can configure the hardware root of trust 1400 into a self-test mode. In the self-test mode, a random number generator 1420 can become a pseudorandom number generator to generate test stimuli. A counter in the controller 1410 can provide test stimuli to test a response register 1430. The test responses outputted from both hashing circuitry 1450 and the response register 1430 are combined by XOR gates 1460. The result is sent to a multiple-input signature register 1440. In the meantime, a control decoder in the controller 1410 can provide test stimuli to test inverter-based ring oscillators in the random number generator 1420. The test responses are also collected by the multiple-input signature register 1440 The test process can be simulated for a no-fault circuit to produce a good-machine signature and for potential faults to determine fault coverage. The signature produced by the multiple-input signature register 1440 can be compared with the good-machine signature to determine whether a fault is detected or not.

Referring back to FIG. 10, the security server 1090 may be implemented by one or more computing systems/devices. Accordingly, one or more of the hash function unit 1095, the configuration mask unit 1097, and the design identification unit 1092 may be implemented by executing programming instructions on one or more processors in one or more computing systems/devices. It should be appreciated that, while the hash function unit 1095, the configuration mask unit 1097, and the design identification unit 1092 are shown as separate units in FIG. 10, a single computing system/device may be used to implement some or all of these units at different times, or components of these units at different times.

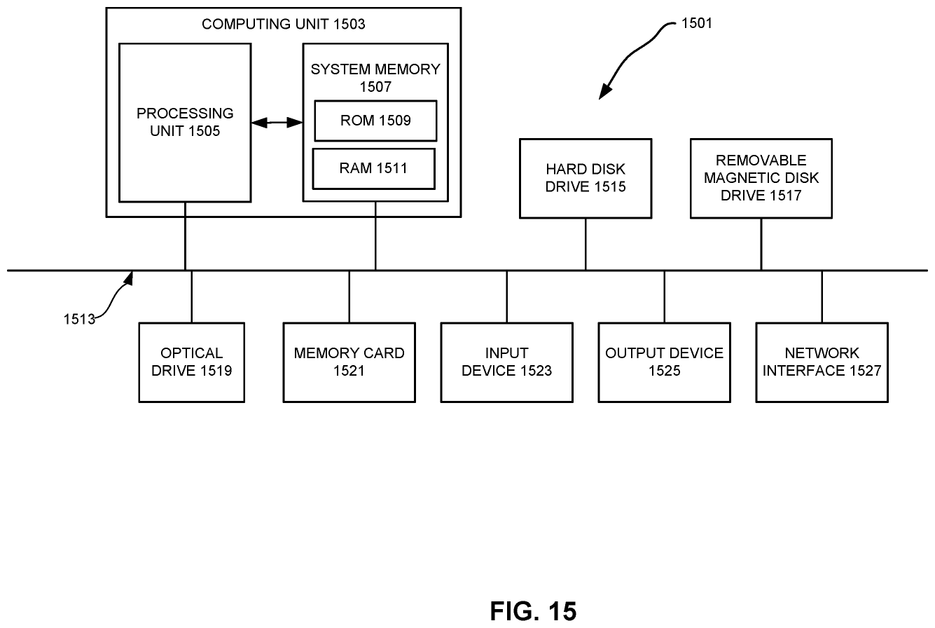

Various examples of the disclosed technology may be implemented through the execution of software instructions by a computing device, such as a programmable computer. Accordingly, FIG. 15 shows an illustrative example of a computing device 1501. As seen in this figure, the computing device 1501 includes a computing unit 1503 with a processing unit 1505 and a system memory 1507. The processing unit 1505 may be any type of programmable electronic device for executing software instructions, but it will conventionally be a microprocessor. The system memory 1507 may include both a read-only memory (ROM) 1509 and a random access memory (RAM) 1511. As will be appreciated by those of ordinary skill in the art, both the read-only memory (ROM) 1509 and the random access memory (RAM) 1511 may store software instructions for execution by the processing unit 1505.

The processing unit 1505 and the system memory 1507 are connected, either directly or indirectly, through a bus 1513 or alternate communication structure, to one or more peripheral devices. For example, the processing unit 1505 or the system memory 1507 may be directly or indirectly connected to one or more additional memory storage devices, such as a “hard” magnetic disk drive 1515, a removable magnetic disk drive 1517, an optical disk drive 1519, or a flash memory card 1521. The processing unit 1505 and the system memory 1507 also may be directly or indirectly connected to one or more input devices 1523 and one or more output devices 1525. The input devices 1523 may include, for example, a keyboard, a pointing device (such as a mouse, touchpad, stylus, trackball, or joystick), a scanner, a camera, and a microphone. The output devices 1525 may include, for example, a monitor display, a printer and speakers. With various examples of the computing device 1501, one or more of the peripheral devices 1515-1525 may be internally housed with the computing unit 1503. Alternately, one or more of the peripheral devices 1515-1525 may be external to the housing for the computing unit 1503 and connected to the bus 1513 through, for example, a Universal Serial Bus (USB) connection.

With some implementations, the computing unit 1503 may be directly or indirectly connected to one or more network interfaces 1527 for communicating with other devices making up a network. The network interface 1527 translates data and control signals from the computing unit 1503 into network messages according to one or more communication protocols, such as the transmission control protocol (TCP) and the Internet protocol (IP). Also, the network interface 1527 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 1501 is illustrated as an example only, and it is not intended to be limiting. Various embodiments of the disclosed technology may be implemented using one or more computing devices that include the components of the computing device 1501 illustrated in FIG. 15, which include only a subset of the components illustrated in FIG. 15, or which include an alternate combination of components, including components that are not shown in FIG. 15. For example, various embodiments of the disclosed technology may be implemented using a multi-processor computer, a plurality of single and/or multiprocessor computers arranged into a network, or some combination of both.

### Conclusion

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

1. A circuit, comprising:
a random number generator, the random number generator comprising:
a ring generator; and
one or more inverter-based ring oscillators, the one or more inverter-based ring oscillators configured to inject bits into the ring generator at a plurality of location.

2. The circuit recited in claim 1, wherein if the one or more inverter-based ring oscillators have more than one inverter-based ring oscillators, the one or more inverter-based ring oscillators have different numbers of inverting elements and inject bits into the ring generator at different locations.

3. The circuit recited in claim 1, wherein at least one of the one or more inverter-based ring oscillators is configured to inject bits into the ring generator at different locations from outputs of some or all inverting elements in the at least one of the one or more inverter-based ring oscillators.

4. The circuit recited in claim 1, wherein the random number generator further comprises:
blocking circuitry configured to convert, based on a blocking signal, the ring generator into a circular shift register by blocking both the injection from the one or more inverter-based ring oscillators and internal feedbacks in the ring generator.

5. The circuit recited in claim 4, further comprising:
a counter configured to generate the blocking signal, the blocking being enabled after a predefined number of clock cycles indicated by the counter.

6. The circuit recited in claim 4, wherein the blocking circuitry comprises a plurality of AND gates.

7. The circuit recited in claim 1, further comprising:
hashing circuitry configured to mimic a hashing function that can transform a random number outputted from the random number generator into a hash value.

8. The circuit recited in claim 7, wherein the hashing circuitry comprises:
combinational circuitry comprising nonlinear Boolean operators formed by logic gates, the combinational circuitry configured to receive the random number; and
a ring generator configured to be initialized by a secret key, to be injected with bits from outputs of the combinational circuitry, and to output the hash value after a predefined number of clock cycles.

9. The circuit recited in claim 7, further comprising:
retrieving circuitry configured to use the hash value to retrieve one or more configuration masks from a response signal received by the circuit,
wherein the response signal is generated based on the random number by a computing device, the generating of the response signal comprising: generating the hash value for the random number, and combining the hash value with the one or more configuration masks.

10. The circuit recited in claim 9, further comprising:
a descrambler configured to use a configuration mask in the one or more configuration masks to descramble a signal received by the circuit.

11. The circuit recited in claim 10, wherein the descrambling the signal comprises retrieving compressed test patterns from encrypted compressed test patterns received by the circuit.

12. The circuit recited in claim 9, further comprising:
a scrambler configured to use a configuration mask in the one or more configuration masks to scramble a signal to be sent out by the circuit.

13. The circuit recited in claim 9, further comprising:
a multiple-input signature register configured to compact test responses during a self-test,
wherein the random number generator is further configured to operate as a pseudorandom test pattern generator by blocking the injection from the one or more inverter-based ring oscillators.

14. The circuit recited in claim 9, further comprising:
a controller configured to supervise an authentication process, the authentication process comprising:
generating the random number by the random number generator,
converting the random number into the hash value by the hashing circuitry, and
retrieving, by the retrieving circuitry, the one or more configuration masks from the response signal received by the circuit based on the hash value.

15. The circuit recited in claim 14, wherein the controller comprises a finite state machine.

16. The circuit recited in claim 14, wherein the controller is further configured to control a test process for self-testing of the random number generator, the hashing circuitry, and the retrieving circuitry.

17. One or more computer-readable media storing computer-executable instructions for causing a computer to perform a method, the method comprising:
creating, in a circuit design, a circuit, the circuit comprising:
a random number generator, the random number generator comprising:
a ring generator; and
one or more inverter-based ring oscillators, the one or more inverter-based ring oscillators configured to inject bits into the ring generator at a plurality of location.

18. The one or more non-transitory computer-readable media recited in claim 17, wherein the controller is further configured to control a test process for self-testing of the random number generator, the hashing circuitry, and the retrieving circuitry.

19. The one or more non-transitory computer-readable media recited in claim 17, wherein if the one or more inverter-based ring oscillators have more than one inverter-based ring oscillators, the one or more inverter-based ring oscillators have different numbers of inverting elements and inject bits into the ring generator at different locations.

20. The one or more non-transitory computer-readable media recited in claim 17, wherein at least one of the one or more inverter-based ring oscillators is configured to inject bits into the ring generator at different locations from outputs of some or all inverting elements in the at least one of the one or more inverter-based ring oscillators.

21. The one or more non-transitory computer-readable media recited in claim 17, wherein the random number generator further comprises:
blocking circuitry configured to convert, based on a blocking signal, the ring generator into a circular shift register by blocking both the injection from the one or more inverter-based ring oscillators and internal feedbacks in the ring generator.

22. The one or more non-transitory computer-readable media recited in claim 17, wherein the circuit further comprises:
hashing circuitry configured to mimic a hashing function that can transform a random number outputted from the random number generator into a hash value.
